(19) United States
(12) Patent Application Publication
(10) Pub. No.: US 2015/0033147 A1
(43) Pub. Date: Jan. 29, 2015

(54) Calendar/time based connected entity(entities) network where as entity refers to "personal/ social /private-public groups/ business / trusts etc. Use / how it works: Design and system processes to link and manage calendar/time using system process/methods i.e. link time, tag /publish calendar, show calendar publicly or privately, set up meeting/gathering/appointment in network users by unique Identity Id. Unique Identity Id is used to link calendars using internet with any electronic devices

(71) Applicant: Sunilkumar M. Patel, Ridgewood, NJ (US)

(72) Inventor: Sunilkumar M. Patel, Ridgewood, NJ (US)

(21) Appl. No.: 13/953,728

(22) Filed: Jul. 29, 2013

(51) Int. Cl. G06F 3/0481; H04L 12/58; G06F 3/0484

(52) U.S. Cl. CPC G06F 3/0481; G06F 3/04842; H04L 51/02
USPC 715/753

(57) ABSTRACT

Calendar/time based connected entity (entities) network whereas entity refers to “individual/social/private-public groups/business/trusts etc. Use/how it works: Design and system processes to link and manage calendar/time using system process/methods i.e. link time, tag/publish calendar, show calendar publicly or privately, set up meeting/gathering/appointment in network users by unique Identity Id. Unique Identity Id is used to link calendars using internet with any electronic devices.

### TECHNICAL FIELD

This invention relates calendar/time based connected entity (entities) network whereas entity refers to “individual/social/private-public groups/business/trusts/community”. Design and system processes to link and manage various calendar/time based day to day activities using a system process/methods, which can potentially help in avoiding unnecessary time waste.

### BACKGROUND

1. Field of Invention

The presented invention generally relates field of communications and social networking which delivers unique process and methods of managing and linking time and calendar, and in particular toward processing calendar or time booking request/response/acknowledgement in network users, manage personal calendar and publishing/subscribing on the internet via any electronic devices connected to internet i.e. computers, laptops, mobiles and set forth.

2. Description of the State of Art

The Invention will allow user to save time (its next generation internet solution to save time when one entity want to schedule time with other, don't have to do multiple calls or be in long phone queue, rather request time with all and get confirmation using electronic communications) and manage it in better way with simple and easy way with all users in network and also helps to manage daily activities, also publish calendar to world for popularity, advertisement, updates and daily activities. To give name and service to the public using this invention, we are going to start with initial given name “Knocktime™” (or any other authorized name) and service will be publically hosted on internet multiple domains.

Invention is mainly system and processes to link and manage time of individual, community and business and set forth. This invention facilitates three wide areas

I>link time/calendar and Manage: Time/Calendar network managed through the creation of secure user with a calendar and unique system ID and Knocktime Identification Number (KIN), add and manage associated time sharing, and then request, link time to network, get alert on upcoming time activity into the calendar. While facilitating this, system identifies and determine time request made and synchronize each user's calendar with other users based on user response, and time request include all set forth users and synchronization of calendar involves appointment, meetings, orders, any scheduling and set forth. Also facilitates, fasted possible way to link or book time with others, listed method and process allow user to book or link a time without interacting or using any other system or any other form of communication. II>Save time with Unique Id: this system facilitates unique Knocktime™ Identification Number—TIN which can be used to manage daily life and have one ID do all your daily activity and this unique id can be used in link to other business process and flows, and set forth. II>Publish Calendar—Publicly or privately for various usage

III>Subscribe: Subscribe or connect with people/business/groups with managed calendar/time based activities, using internet with any electronic device such as computers, pads, mobiles, digital electronic devices, scanning devices etc.

3. Background

In presently available networking website, none of the service provider has feature to link calendar/time, majority of them link “messages”, “profiles”, “updates”, “activities”, “tags”, “View calendar”, “Group calendar” but none of the public social networking service provider has feature to link “Time” and publish/subscribe calendar broadly as mentioned, as provided with ‘Knocktime™’ or other authorized name with public domain and associated process and activities such as time request, save date, calendar synchronization and set forth.

### SUMMARY

“Knocktime™”—capable of managing Calendars/Time with connected social network, daily gathering/meeting/appointment/time book with individuals and business and community based time/calendar network. This application facilitates linking people using calendar and managing daily life more conveniently using next generation Internet based Web based global application where people.

Overview of Process and Features:

Below are features and details of how it works.
Knocktime™ is a time management system with set of process and methods that organizes User's world. It can perform appointments, meetings, reservations, requests using single id “KIN” number (Knocktime™ ID)—Manager your social activities by requesting time using Knocktime™ id and all surround business request ( Appointments/Orders/Meetings etc.) using “KIN” number (Knocktime™ ID).
How it works:
   No need to spend minutes or hours of your time, making phone calls to set up appointments or connecting with others. Just ping time to your world by. We will confirm time one each end without single phone call.
   Unmanaged Appointments—No problem. Manage your calendar with all your daily activities. Link up with people and businesses and much more. Wouldn't it be great if you can track the minutes, and hours in a day, furthermore the weeks and months in a year. Now you can with Knocktime™!!
   The most valuable asset next to money is time. Only if you can buy it, and save it when time matters.
Individual User Features:
   Link time with millions of users, sharing and saving valuable time using Knocktime™
   Add more time to your day with Knocktime™, and spend more time with your friends and family.
   Simply ping your time in Knocktime™ using our calendar (available for PC, Cell Phones and Mac) or by entering email or phone number of others. Knocktime™ allows you to interact with each other, to share special dates and times for which you might be end up calling multiple time or in doing voicemail each other or in case to get appointment, meeting and reservation with business you will end up being long queue of hold, this all you can do with single click using Knocktime™.
Community User Features:
   Community/Group are a way for all to come together around a common time sharing interest, such as a sporting event, a wedding, a graduation. With Knocktime™ you can create your own group and book everyone's time
   Groups can either be public, public (invite only), or completely private. Every group can create event and request all to join event, share time and functions and a time slot for any needs.
Business Features:
   Why the BUSINESS? Business needs People, and People need Business. A person is dependent on many daily needs like Doctors, Foods, Transporting, Professional Services and many more. Business and Person both would be able to keep track of their mutual needs using Knocktime™.
   Appointments, Interviews, Reservation, Meetings and Special requests

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a model diagram illustrating an overview of time/calendar based request/response processes, according to some embodiments of the invention.

FIG. 2 is an overview of flow diagram illustrating a process for setting up time/calendar request between users and manages them, according to some embodiments of the invention.

FIG. 3 is a dashboard diagram illustrating a various processes for time/calendar based associated events, according to some embodiments of the invention.

FIG. 4 illustrates the GUI display of search users with calendars, according to some embodiments of the invention.

FIG. 5 illustrates the GUI display of user's public/private calendar based on user's settings, according to some embodiments of the invention.

FIG. 6 is a flow diagram illustrating a process for linking two calendars, according to some embodiments of the invention.

FIG. 7 illustrates the GUI display of a business user incoming request center, according to some embodiments of the invention.

FIG. 8 illustrate client/server diagram for various communications, according to some embodiments of the invention.

### DESCRIPTION OF EMBODIMENTS

Examples of a method, apparatus, and computer program for presenting a world view of content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

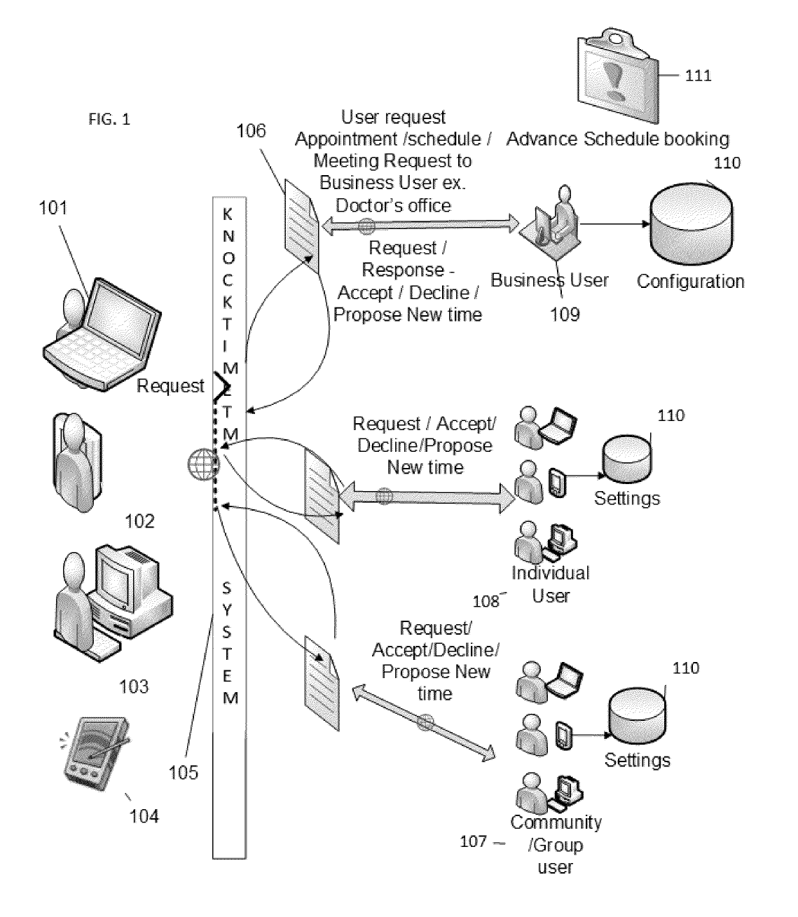

FIG. 1 is a model diagram illustrating an overview of time/calendar based request/response processes, according to some embodiments of the invention. One skilled in the art will appreciate that there may be hundreds of different topologies, but the simple system shown in FIG. 1 helps demonstrates the very high level broad operation of the calendar based timely connected network between different entities like individual/community/business user. There may be n-number of users and n-number of networks connected to each other for their time based calendar network.

FIG. 1 shows electronic devices with internet 101-104, Processor System 105, Time request and response message 106, Community/group user 107, Individual user 108, business user 109, business configuration 110, schedule booking 111.

The various internet connected systems 101-104 can be utilized authorized access to time/calendar network system—Knocktime™ 105, user can create accounts in system and get their unique userid/KIN to login into system and this unique ID is used various operations, such as request time 106, publish/subscribe calendar, link calendar, billing and set forth reference. Time requests 106 contain various type of time requests i.e. meeting, appointments, party, business time booking, save date etc.

Individual user 108 is core entity where individual can do multiple operations, primarily link calendar with all other types' users (individual, community/group and business), their calendar access based on provided access from other user and vice-versa. Individual user 108 can publish/subscribe calendar publicly/privately based on their setting. Individual public calendar can be used for advertising and set forth number of sharing events/activities. Individual user 108 can sent various types of time requests to other Individual, Community/group and business user i.e. simple time block, group time booking, save date, party, appointments, meeting, business time booking etc.

Community/group user 107 is another type of entity where Community/Group user can do multiple operations, primarily link calendar with all other types' users (individual, community/group and business), their calendar access based on provided access from other user and vice-versa. Community user 107 can publish/subscribe calendar publicly/privately based on their setting. Community public calendar can be used for advertising and set forth number of sharing events /activities. Community user 107 can sent various types of time requests to other Individual, Community/group and business user i.e. simple time block, group time booking, save date, party, appointments, meeting, business time booking etc.

Business user 109 is another type of entity where Business user 109 can do multiple operations, primarily link calendar with all other types' users (individual, community/group and business), their calendar access based on provided access from other user and vice-versa. Business user 109 can publish/subscribe calendar publicly/privately based on their setting. Business public calendar can be used for advertising and set forth number of sharing events/activities. Business user 109 can sent various types of time requests to other Individual, Community/group and business user i.e. simple time block, group time booking, save date, party, appointments, interviews, meeting, business time booking etc. Business configuration 110 is used to set up additional business flow where business can start taking appointments, orders, fax, calls using their KIN and customer KIN to block time between two or set forth usage. Business configuration 110 allows business to setup their online store and when other user access business user using Knocktime™ they can do multiple requests, 1—time request, 2—directly get transferred to business own website and 3—Knocktime™ business store if it was setup. 111 business have advance scheduling option based on time request made to business, today individual have to wait in long phone queue for setting up appointment/meeting/booking but using Knocktime™ individual user and business user interactively confirm time without talking to each other using request/response/proposed time. Using advance scheduling 111 businesses can take appointments automatically for in network/connected users.

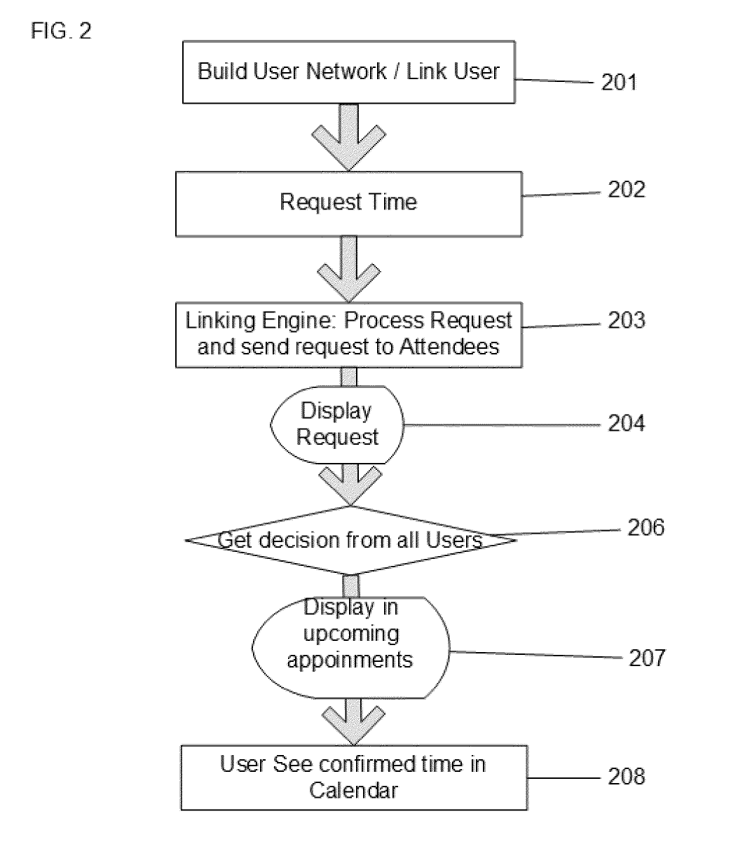

FIG. 2 is an overview of flow diagram illustrating a process for setting up time/calendar request between users and manages them, according to some embodiments of the invention. Throughout the discussion of FIG. 2 and its associated method, the above-described various types of time requests will be used to further illustrate the method. Though a skilled artisan understand that, just like the system described above, the method of FIG. 2 may also be practiced in different system environments wherein time request by various types of user components may be varied for optimized distribution and usage.

Once user has profile created in Knocktime™ system, user can connect to any other type of user to build their calendar sharing network 201. User network 201 is time/calendar based connect user network where user can be individual, community/group and business user. Network is permission based like other social networking i.e. LinkedIn, one user to send request to connect and other accept to get into each other's network with provided permissions of calendar view, share, and time request.

User can request time 202 in form of any particular needs i.e. save date, meeting, appointment, business time booking, restaurant booking, party, gathering etc. Time request 202 contains from User, To User(s), Type of request and request details. User can request time 202 to any other type of in network user. Once request made, Knocktime™ linking engine 203 process requests and send it to appropriate entities for their reply/response. Once request delivered, recipient user dashboard show new time request 204 in there dashboard. Each and every reply/response recorded by Knocktime™ engine 206 and whoever has accepted time request will show up in there dashboard as upcoming appointments 207. Upcoming appointment in dashboard when clicked, show all detail about all recorded reply and responses 208. This is basic flow however it contains many different flows between different types of users based on specific user and needs i.e. interaction between individual user and business user.

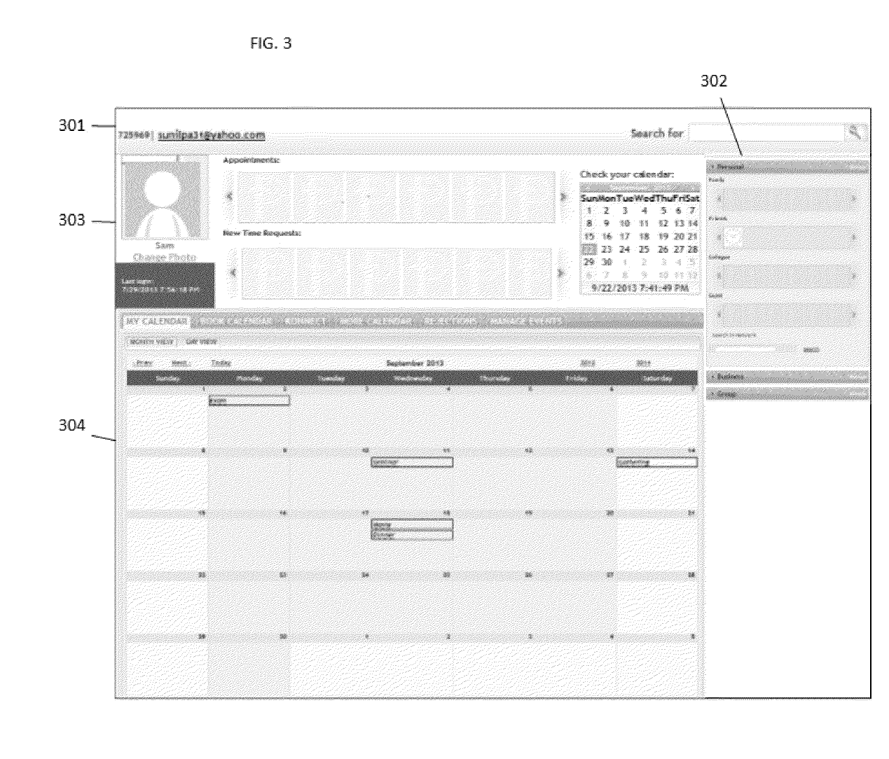

FIG. 3 is a dashboard diagram illustrating a various processes for time/calendar based associated events, according to some embodiments of the invention. User dashboard is different for each type or user, FIG. 3 illustrate most common feature of user dashboard, contains multiple sections of the calendar. Once user login to the system, based on authentication and authorization will be redirected to dashboard. Top section of the dashboard 301 contains KIN—Knocktime™ identification number, primary email and quick search capabilities for sending time request to other user as mentioned above. In Network users 302 displayed in right side of the dashboard, once user linked to other user Personal (Individual), business and community user, displays connected user. In network user 302, when accessed left side it will display selected user's calendar based on provided permissions and multiple activities can be done here—Send time request as referred above, comment something on other user's calendar, view calendar. Profile picture 303, displays user image set by user and some of important information such as when last login etc. In 303, user can see next upcoming appointments, as and when any time request accepted or sent, it displays here with user's profile picture, it displays sender's/initiator's profile picture. If time request made by logged in user, it will display logged in user's profile picture. When user clicks on any of appointments picture, in 304, it will show each and every detail of time request with all entity involved. In 303, user can see new time request made to user and display's sender's profile picture. When clicked on new request, it will display all details about request in 304. Left bottom panel 304 mainly shows to perform multiple calendar based activities as described above. In 303, it shows menu with different process with reference to specific embodiments—“My Calendar (Month and Day view with print option)”, “Book calendar”, “Konnect (connect)”, “More Calendars”, “Rejections” and “Manage events”.

In 304, “My Calendar” process and displays logged in user's calendar by month and day view with various calendar options to see present and future activities, similarly Day view shows day's activities and print options. In this user can do self-time blocking for various types of day to day activities i.e. shopping, gym, reminders etc.

In 304, “Book calendar” process and provide user to various type of time request as mentioned above to different type user, here user can search other user—individual, community, business—and can send time request.

In 304, “Konnect (Connect)” process used to link one user to other user by sending each other joining request to build there calendar based connected network.

In 304, “More Calendars” process and shows user's calendars in various filtered views i.e. calendar with personal activates, calendar with personal user group, calendar activities with community and businesses.

In 304, “Rejections”—When time request is rejected by user, it displays here to reconsider in future or view and provide comments on rejected time requests.

In 304, “Manage events”—once time request sent changing any property of time request this process is used.

FIG. 3 is for illustration purpose only for various processes and methods with reference to specific embodiments.

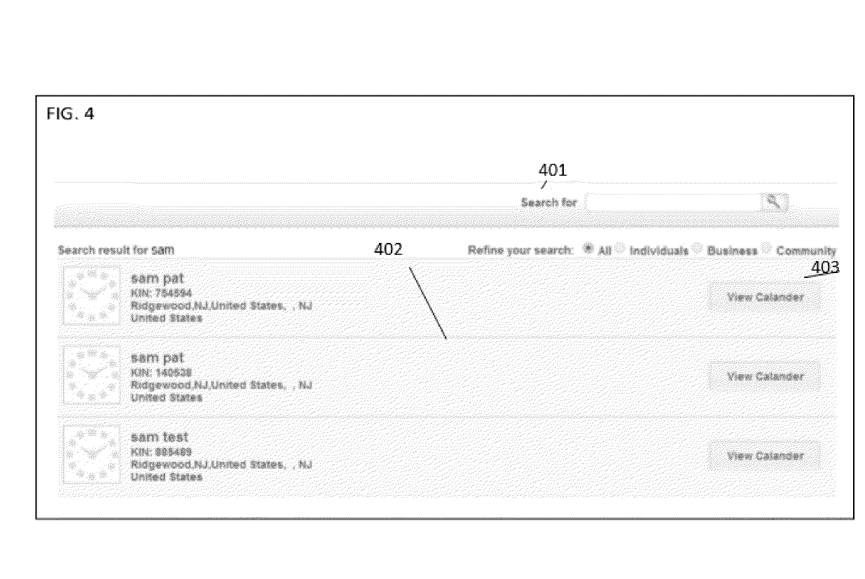

FIG. 4 illustrates the GUI display of a search user to view their calendars, according to some embodiments of the invention. Search 401 processes to search user and view their calendar without logging into system if user has setup calendar to view publicly. Search 401 is free text search and search engine will pull data from nearest geographical match to farthest based on math. If multiple match 402, it will multiple users and can be filtered further between different type of users. View Calendar 403 process user calendar and if selected user have provided permission, user's public calendar will be display with and without logging to system.

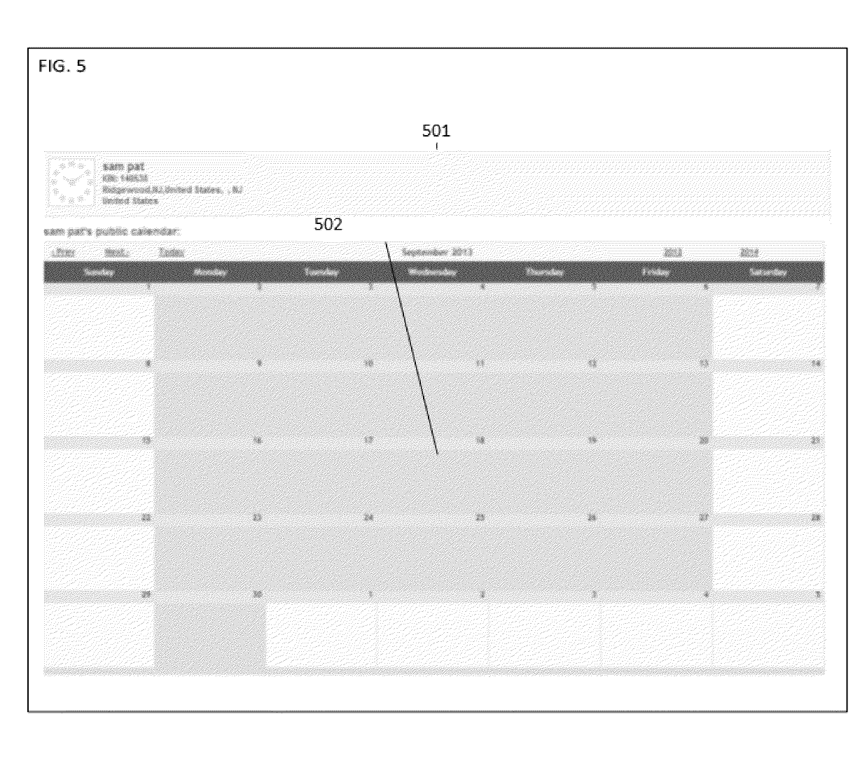

FIG. 5 illustrates the GUI display of user's public/private calendar based on user's settings, according to some embodiments of the invention. User can publish their own public calendar on internet i.e. http://knocktime.com/dir/pub/sam/754594 to share it with world on other networking sites. As per user setting if user has provided permission, read or read/comment, another user can view user's calendar, and will display booked time with various type of requests. Also, further setting available for in network and outside network visibility. When user View calendar clicked as describe above in 403, system will process calendar of selected user and will display user profile details 501 and user's current month calendar 502, with different calendar operations. User can publish some advertisements in calendar or outside of calendar in user's public calendar.

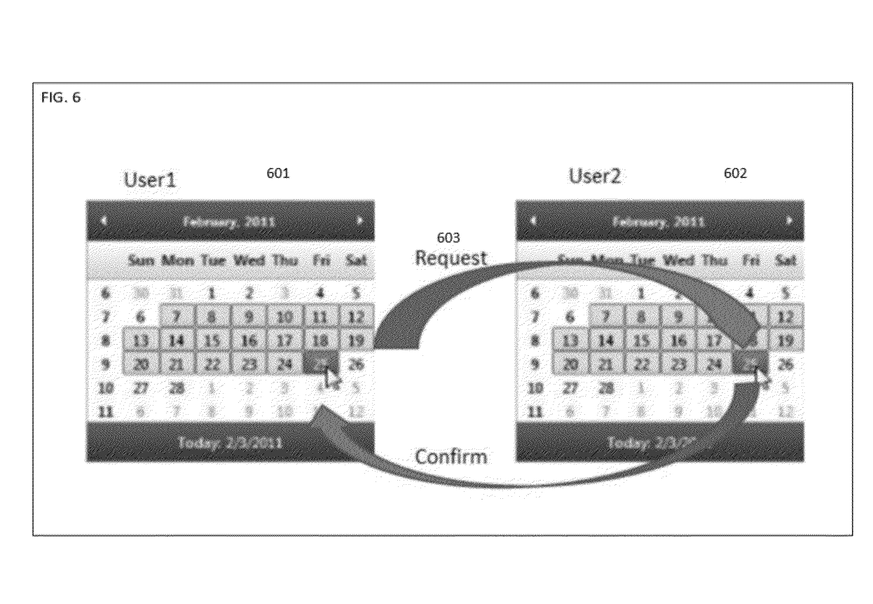

FIG. 6 is a flow diagram illustrating a process for linking two calendars, according to some embodiments of the invention. Knocktime™ linking engine, process time request 603 from User1 601 to User2 602 systemically by validating request, delivering it and keep track of it. After User2 602 gets request and send appropriate response back to User1 601, that specific time is blocked in both calendars. However user is not restricted to one particular time request, at same time user may have multiple time request booked in calendar, it up to user how user want to manage calendar/daily activities.

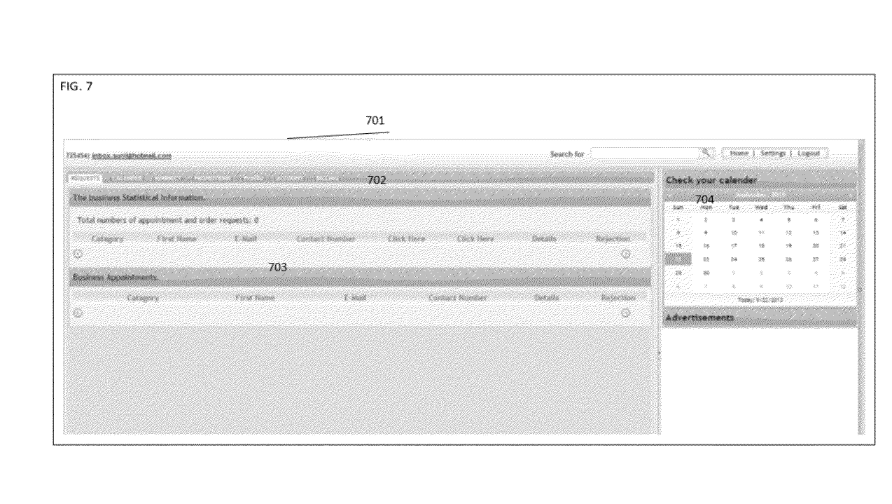

FIG. 7 illustrates the GUI display of a business user incoming request center, according to some embodiments of the invention. Business user dashboard has more advance features of managing time requests. System can automatically accept and book time for their customer as per business configuration. Business dashboard shows business user detail and search capabilities on top 701.

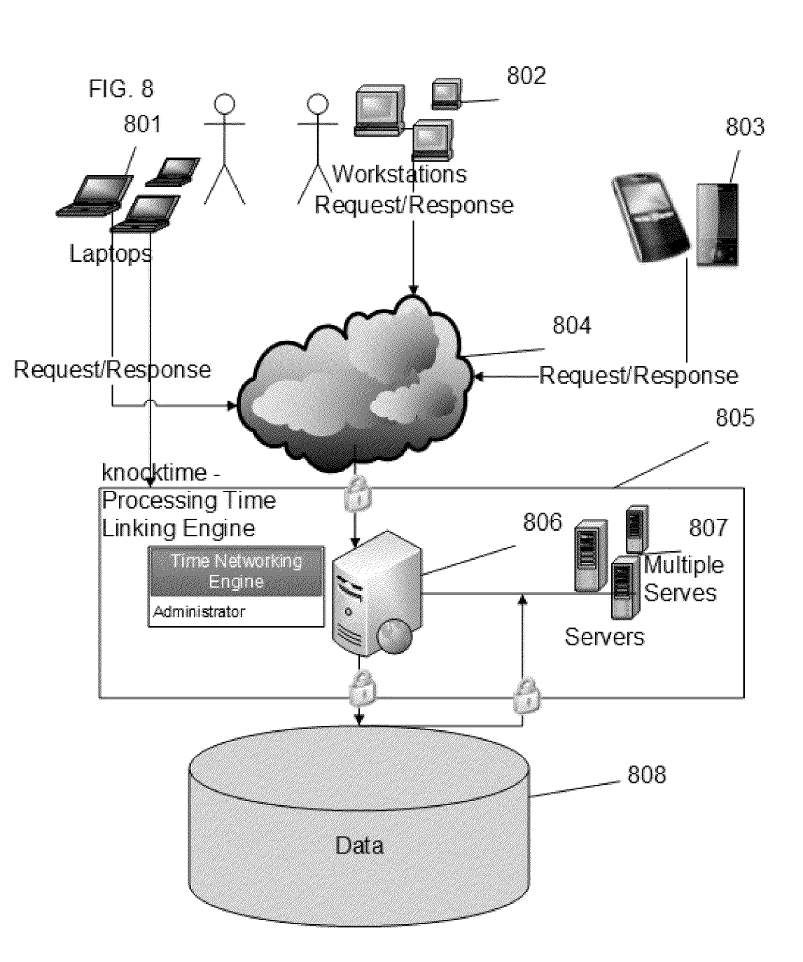

FIG. 8 illustrate client/server diagram for various communications, according to some embodiments of the invention. Client-Server diagram shows overall generic system architecture where multiple clients 801, 802, 803 use internet webpage or client application to access program over internet 804 from server 805. Server is capable of processing millions of clients' request using load balancing 807 and based on different geographical area across world. Server maintained by administration/profession engineering team, Program hosted and implemented on server and server above describe processes and methods using webpage or client application with secured electronic transfers 806 and all activities get stored in database 808 with multiple database servers and procedures.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed:

1. A method/Design of time/calendar based connected user network and processes to link and manage time/calendar of individual, community and business network and/or set forth: creation, by a computer system/mobile or any internet connected electronic device, calendar connections among multiple users in a network of associated users; time storing, by a computer system/mobile or any internet connected electronic device, calendar information on the connections in a database; locating, by a computer system/mobile or any internet connected electronic device, a desired webpage; identifying, by a computer system/mobile or any internet connected electronic device, a User1 creates time request on webpage; identifying, by a computer system/mobile or any internet connected electronic device, in time request add recipient users by email or KIN—Knocktime Identification Number or in Network users and send it, by a computer system/mobile or any internet connected electronic device, show new time request link as new time requests with detail, about the request sent; identifying, by a computer system/mobile or any internet connected electronic device, a User2 views time request, time request sent by User1 on webpage; looking up, by a computer system/mobile or any internet connected electronic device, recipient user accepts or rejects request by webpage, by a computer system/mobile or any internet connected electronic device, and once accepted or rejected its tracked in all in scope users for this time request webpage; assigning, by a computer system/mobile or any internet connected electronic device, a way to the link time based calendar in part on the identified relationship, request, response, reject and managing calendar network; and determining and management, by a computer system/mobile or any internet connected electronic device, search and view users calendar publicly based on their permission/filter and setting, by a computer system/mobile or any internet connected electronic device, view appointment available from business users and request any type to time request to any subject, from one entity to other entity, one to many, entity can be personal user, businesses, communities, groups, by a computer system/mobile or any internet connected electronic device.

2. A non-transitory computer-readable medium on which is encoded program code, the program code comprising: program code for determining calendar/time connectivity between two entity, planning—managing time, between a plurality of users in a network or by KIN—Knocktime Identification Number or by email; program code for storing information on the connections in a database; program code for locating a desired webpage; program code for identifying a first user1 of the desired webpage; program code for identifying a time/calendar link in the desired webpage that directs to a linking calendar; program code for identifying a second user of the linking calendar; program code for looking up the information to identify a calendar/time connectivity between the first user of the desired calendar webpage and the second user of the linking webpage; program code for requesting a time to book and link calendar at least in part on the identified relationship; and program code for determining a time next generation public calendar helps planning, saving time and management for the desired calendar webpage in search results based at least in part on the time based connected network.

3. A method comprising: identifying, by a computer system/mobile or any internet connected electronic device, a desired time/calendar webpage and a link in the desired webpage that directs to a linking calendar webpage; determining, by a computer system/mobile or any internet connected electronic device, a first entity associated with the desired calendar webpage; determining, by a computer system/mobile or any internet connected electronic device, a second entity associated with the linking calendar webpage; determining, by a computer system/mobile or any internet connected electronic device, a relationship between the first entity of the desired calendar webpage and the second entity of the linking calendar webpage based at least in part on connections information of entities that are part of a time/calendar network; and classifying, by a computer system/mobile or any internet connected electronic device, the connected time link based at least in part on the determined relationship between the first entity and the second entity.

4. The method of claim 3, wherein the first entity is determined to be associated with the desired calendar webpage is responsive to the first entity being any user—personal, business or community of the desired webpage.

5. The method of claim 3, wherein the first entity is determined to be associated with the desired webpage responsive to the first entity being responsible for the calendar design, implementation, or maintenance of the desired webpage.

6. The method of claim 3, wherein determining a first entity associated with the desired webpage comprises searching the desired calendar visibility information that identifies an administrator of the desired webpage.

7. The method of claim 3, wherein determining a first entity associated with the desired public calendar webpage comprises querying a domain name registration service for an administrator of the desired webpage.

8. The method of claim 3, wherein the first entity associated with the desired webpage is identified by analyzing calendar view patterns of users to the desired webpage.

9. The method of claim 3, wherein the connections information describes associations between members of a calendar based timely linked social network.

10. The method of claim 3, wherein the connections information describes types of associations between members of a social network and the weight assigned to each association type.

11. The method of claim 3, wherein classifying the calendar link comprises: assigning a searching weight to the link based at least in part on the determined time based connection between the first entity and the second entity; and determining a calendar for the desired webpage in search results based at least in part on the weight assigned to the calendar link.

12. A method comprising: identifying, by a computer system, a public calendar advertisement; determining, by a computer system/mobile or any internet connected electronic device, a first entity associated with the advertisement by time and schedule; identifying, by a computer system/mobile or any internet connected electronic device, an access point to the advertisement; determining, by a computer system/mobile or any internet connected electronic device, a second entity associated with the calendar access; determining, by a computer system/mobile or any internet connected electronic device, a relationship between the first entity and the second entity based at least in part on timely based connection information of entities that are part of a network; and classifying, by a computer system/mobile or any internet connected electronic device, the access point based at least in part on the determined association between the first entity and the second entity.

13. The method of claim 13, wherein an administrator of the advertisement of public calendar is determined to be the first entity associated with the advertisement. First entity is associated with the advertisement is responsive to the first entity being responsible for setting up calendar design, implementation, or maintenance of the advertisement. First entity associated with the advertisement comprises searching the tasks in calendar for information that identifies an administrator of the advertisement. First entity associated with the advertisement is identified by analyzing Calendar patterns of users to the advertisement.

14. The method of claim 13, wherein determining a second entity associated with the Calendar view point comprises: identifying a Calendar address corresponding to the access point; and determining an entity associated with the Calendar and name.

15. The method of claim 13, wherein determining a second entity associated with the Calendar comprises querying an associated with the view calendar/view incoming requests. Second entity associated with the Calendar is identified based on login and after login an embedded cookie of the access point.

16. The method of claim 13, wherein the calendar/time connections information describes associations between members of a social network. The connections information describes calendar/time based associations between members of a social network and the weight assigned to each association type. View calendar comprises assigning a weight to the access point based at least in part on the determined time based connected relationship between the first entity and the second entity.

17. A non-transitory computer-readable medium on which is encoded program code, the program code comprising: program code for identifying a desired webpage and a calendar in the desired webpage that directs to other calendar webpage; program code for determining a first entity associated with the desired webpage; program code for determining a second entity associated with the linking calendar webpage program code for determining a time share between the first entity of the desired webpage and the second entity of the calendar webpage based at least in part on connections information of entities that are part of a time share network; and program code for classifying the calendar based at least in part on the determined relationship between the first entity and the second entity.

18. A non-transitory computer-readable medium on which is encoded program code, the program code comprising: program code for identifying an calendar appointment/events/bookmarks advertisement; program code for determining a first entity associated with the advertisement; program code for identifying an access point to the advertisement; program code for determining a second entity associated with the access point; program code for determining a relationship between the first entity and the second entity based at least in part on calendar based connections information of entities that are part of a network; and program code for classifying the access point based at least in part on the determined association between the first entity and the second entity.

19. A KIN (Knocktime Identification number) referred to be unique number to book time between two or more entities.—Utilizing a unique KIN to link with each other, people/business process and flows, and all activities as set forth. KIN can be uniquely referred as pass code to interact with business that uniquely identifies individual for security.

20. The concept, booking time between entities, allows entities to connect with each other without uses of voice based communication. Time book can be referred to plan and organize any type of timely connected activities and set forth.
Where in above, entities referred to as individuals, community and businesses.
